(19) United States
(12) Patent Application Publication
(10) Pub. No.: US 2014/0020635 A1
(43) Pub. Date: Jan. 23, 2014

(54) Image-Based Animal Control Systems and Methods

(71) Applicant: Radio System Corporation, Knoxville, TN (US)

(72) Inventors: Michael Sayers, Kodak, TN (US); Duane Gerig, Knoxville, TN (US); Travis Vickery, Knoxville, TN (US)

(73) Assignee: Radio Systems Corporation, Knoxville, TN (US)

(21) Appl. No.: 13/646,128

(22) Filed: Oct. 5, 2012

Related U.S. Application Data
(60) Provisional application No. 61/543,534, filed on Oct. 5, 2011.

(51) Int. Cl. A01K 15/02

(52) U.S. Cl. CPC A01K 15/021
USPC 119/721; 348/143

(57) ABSTRACT

Systems and methods of tracking an object within the field of view of an image sensing device. The system can include an animal control system having an image sensing system to determine a location of a pet within a field of view of the image sensing device, a controller to define a pet containment border within the field of view and to compare the location of the pet relative to the defined border, and a transmitter to transmit a stimulation signal to the pet to encourage or discourage the pet from crossing the border based on the comparison.

### CROSS-REFERENCE TO RELATED APPLICATIONS

This application claims the benefit of U.S. Provisional Patent Application No. 61/543,534, filed on Oct. 5, 2011.

### FIELD OF INVENTION

The present general inventive concept relates to systems and methods of controlling animals and associated objects, and more particularly, to image-based tracking systems and methods capable of controlling animals and/or other objects based on visual and/or audible activity occurring within a field of view of one or more cameras.

### BACKGROUND

It is often desirable to contain animals within a given boundary, and to identify when an animal has left such a boundary. Conventional electronic animal containment systems typically employ a buried wire to define a containment barrier. The wire radiates a signal that is sensed by a device worn by a monitored animal. As the monitored animal approaches the perimeter, the signal is sensed and the device delivers a stimulus to the animal to dissuade it from breaching the perimeter.

Global positioning systems (GPS) have also been used to define the boundaries of a selected containment area. In such systems, the position of the animal(s) to be confined is monitored through the use of GPS satellites to determine if and when the animal crosses a boundary. Typically, a portable programming transceiver is used to program the boundary of a selected confinement area as the device is moved along such boundary. A programmable collar transceiver worn by the animal provides GPS signals from the satellite to a remotely located control station. The control station tracks the movement of the animal relative to the boundary. If the animal crosses the boundary, the station transmits a stimulus activation signal to the collar so that a corrective stimulus may be produced for the animal. Tracking and containment of objects are accomplished by providing GPS-defined, user-programmable containment areas

### BRIEF SUMMARY

The present general inventive concept provides a camera-based tracking system to track the location of objects, such as dogs or other animals relative to a virtual border defined within a field of view of one or more cameras. As used herein, the term “camera” is meant to include various types of image capturing devices, including CCD or CMOS cameras, infrared detectors, laser detectors, semiconductor detectors, scanning devices, or other known or later developed image sensing devices.

In some embodiments, the present general inventive concept provides a camera-based tracking system capable of controlling animals and/or other objects based on visual and/or audible activity occurring within a field of view of one or more cameras.

Additional features and embodiments of the present general inventive concept will be set forth in part in the description which follows and, in part, will be obvious from the description, or may be learned by practice of the present general inventive concept.

Example embodiments of the present general inventive concept can be achieved by providing a pet containment system, including a camera system to visualize a location of an animal within a field of view of the camera, a controller to define a border within the field of view and to compare the location of the animal relative to the defined border, and a transmitter to transmit a stimulation signal to the animal to dissuade the animal from crossing the border based on the comparison.

Example embodiments of the present general inventive concept can also be achieved by providing an animal tracking system including a camera system to visualize a location of an animal within a field of view of the camera, a controller to define a border within the field of view and to compare the location of the animal relative to the defined border, and a transmitter to transmit a control signal to actuate a predetermined device based on the comparison.

Example embodiments of the present general inventive concept can also be achieved by providing a method of tracking an animal, including visualizing a location of an animal within a field of view of a camera, defining a border within the field of view, comparing a location of the animal relative to the defined border, and transmitting a signal to the animal to dissuade the animal from crossing the border based on the comparison.

Example embodiments of the present general inventive concept can also be achieved by providing a camera system to track a location of an animal, including a viewing element to establish a field of view of the camera system, a controller to define a border within the field of view and to compare the location of the animal relative to the defined border, and a transmitter to transmit a stimulation signal to the animal to elicit a predetermined behavior of the animal based on the comparison.

Example embodiments of the present general inventive concept can also be achieved by providing an animal tracking system, including a camera system to visualize an animal and a user within a field of view of the camera system, a controller to analyze movement of the user in the field of view to determine whether the movement constitutes a control command, and a transmitter to transmit a control signal to the animal and/or to actuate a predetermined device associated with the animal.

Example embodiments of the present general inventive concept can also be achieved by providing an animal control system, including an image sensing device to detect the presence of an animal within a field of view of the image sensing device, a controller to determine a location of the animal relative to the field of view, and a transmitter to transmit a stimulation signal to the animal to elicit a desired behavior of the animal based on the location of animal within the field of view.

Example embodiments of the present general inventive concept can also be achieved by providing an animal control system, including an image sensing device to detect the presence of an animal within a field of view of the image sensing device, a controller to determine a location of the animal relative to the field of view, and a transmitter to transmit a command signal to an object in proximity to the animal based on the location of the animal within the field of view.

The image sensing device can detect a light signal emitted from a beacon device worn by the animal, an infrared heat signal emitted by the animal, and/or a gesture performed by a user within the field of view.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 is a perspective view of a system environment in which example features of the present general inventive concept may be implemented;

FIG. 2 is a perspective view of the system environment of FIG. 1, illustrating a pet attempting to escape a containment boundary according to an example embodiment of the present general inventive concept;

FIGS. 3 and 4 illustrate a display screen illustrating the position of the pet relative to the containment borders corresponding to FIGS. 1 and 2, respectively;

FIG. 5 is a flow chart illustrating an example routine performed by circuitry programmed to track an object according to an example embodiment of the present general inventive concept;

FIG. 6 is a flow chart illustrating an example routine performed by circuitry programmed to define a pet containment boundary according to an example embodiment of the present general inventive concept;

FIG. 7 is a flow chart illustrating an example routine performed by circuitry programmed to track an object according to an example embodiment of the present general inventive concept;

FIG. 8 is a flow chart illustrating an example routine performed by circuitry programmed to track an object relative to boundary zones according to an example embodiment of the present general inventive concept,

FIG. 9 is a perspective view of a system environment illustrating a pet attempting to enter a defined boundary according to an example embodiment of the present general inventive concept;

FIG. 10 is a perspective view of a system environment illustrating a user providing control signals to the camera in accordance with an example embodiment of the present general inventive concept; and

FIG. 11 is a block diagram of a camera-based control system configured in accordance with an example embodiment of the present general inventive concept.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

It is noted that although the example embodiments described herein are described in terms of a “camera-based” animal containment system, the present general inventive concept contemplates the use of a variety of image capturing devices, including CCD cameras, CMOS cameras, infrared detectors, laser detectors, semiconductor detectors, scanning devices, and other known or later developed image sensing devices. All such image capturing devices are intended to be encompassed within the scope and spirit of the present general inventive concept.

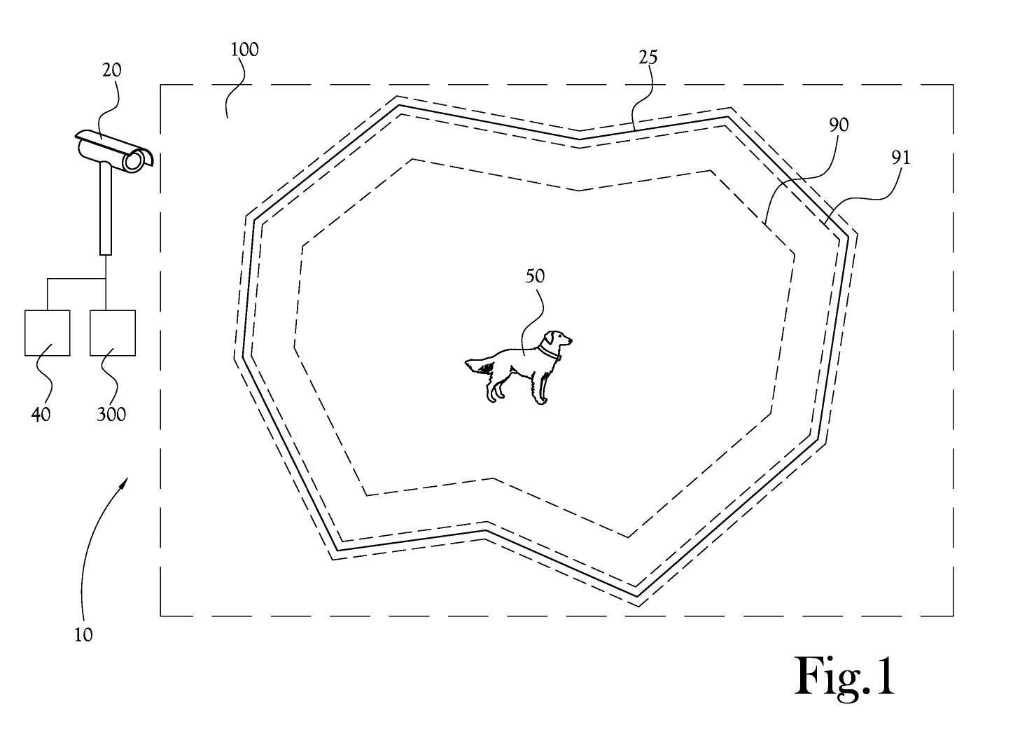

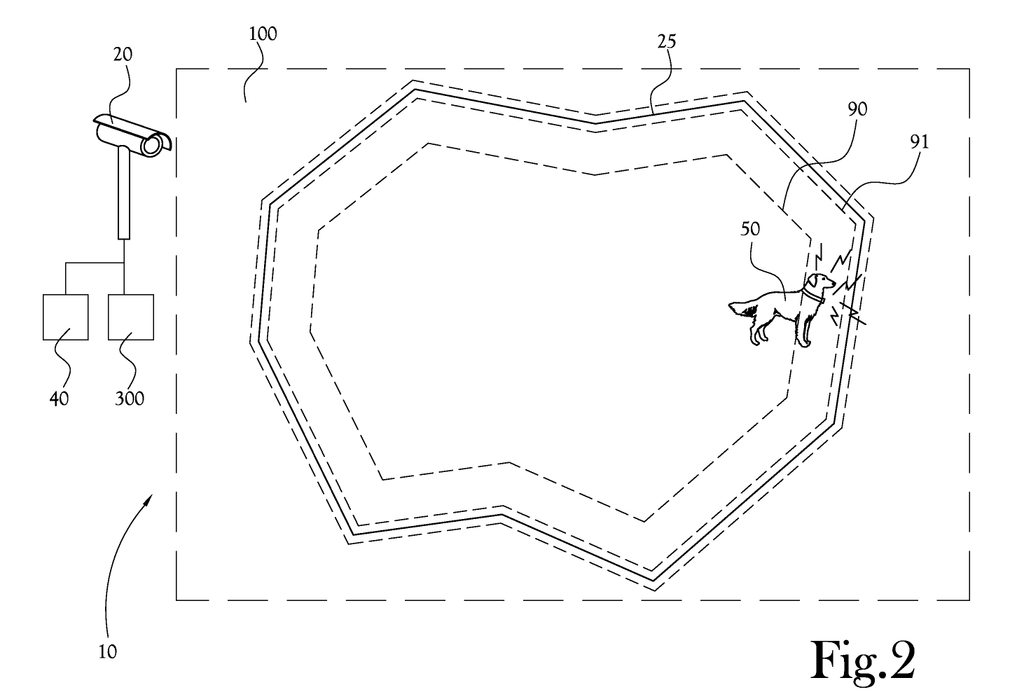

An example camera-based pet containment system is represented as reference number 10 herein and in the accompanying drawings. Referring to FIGS. 1 and 2, the system 10 utilizes an image capturing device, such as camera 20, to define a field of view 100 of a usable area, such as a yard or indoor living area.

As illustrated in FIGS. 1 and 2, an example camera-based vision system 10 can be readily used outdoors or indoors to define a boundary and to capture still or moving images of objects and/or animals within a field of view of the camera 20 to dissuade animals from escaping or entering the defined boundary area, and/or to encourage animals to perform a desired behavior, based on the location of the animal relative to the boundary. For example, when used outdoors, as illustrated in FIG. 1, the system 10 can reduce the need, and associated cost, of burying wire around the perimeter of property to define an electronic boundary. Night vision cameras, such as infrared detectors, can be implemented for low light applications. The camera unit 20 can include an object recognition unit or other image sensor to recognize objects within the field of view of the camera to facilitate definition of a particular boundary, and to recognize the presence of animals or other objects within the field of view of the camera to trigger a stimulus signal to the animal. For example, the camera 20 can capture still or moving images of the animal to determine whether or not to correct the animal, based on the captured image. The stimulus signal can be any stimulus intended to motivate a desired behavior, such as an electronic stimulus or an audio/video stimulus, including a rewarding stimulus or a corrective stimulus.

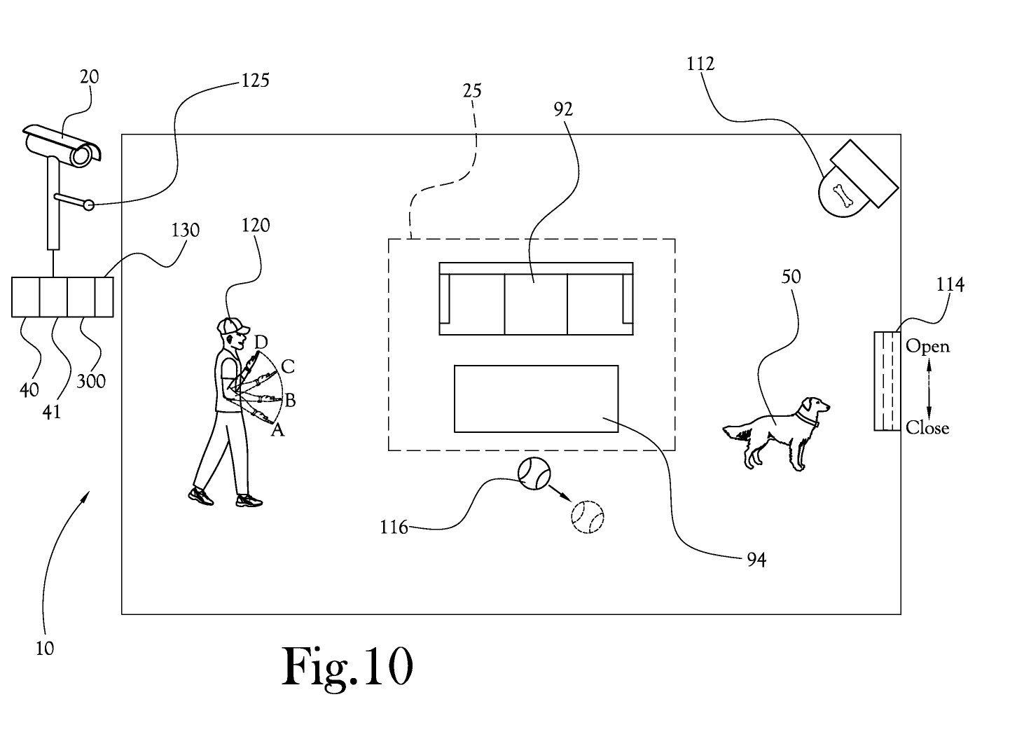

In some embodiments, the image capturing system 10 can recognize the proximity of an animal with respect to objects such as animal feeders/watering devices, pet doors, litter boxes, toys, etc., and can transmit signals to activate and/or deactivate such devices based on the animal's location. The system can transmit signals to the animal and to associated devices in response to a user input, either remotely, such as over a network, or directly, via a user interface. The system can also allow a user to interact with a pet when the user is in the field of view of the camera along with the pet. For example, as described in more detail in connection with FIG. 10, the image capturing system 10 can recognize signals provided by a user in the field of view, such as hand gestures, and can transmit a stimulus to the animal(s), as well as transmit control signals to associated devices, such as pet doors, treat dispensers, toys, etc., based on the user's input within the field of view.

Referring again to FIGS. 1 and 2, the example system 10 is illustrated using a single fixed camera 20 to provide a predetermined field of view. Although these figures show a single camera 20, it is possible for the camera system 20 to implement multiple cameras to provide additional or increased fields of view, including one or more of a variety of different types of cameras, and/or combinations thereof, such as single or multiple fixed or panning cameras, night vision cameras, and/or dual cameras to improve depth perception or other visual characteristics, without departing from the scope and spirit of the present general inventive concept. In some embodiments, the cameras can be powered by solar, battery, or grid AC/DC power supplies, but it is possible to use other known or later developed power sources chosen with sound engineering judgment, as desired.

As illustrated in FIGS. 1 and 2, the example system 10 includes a camera 20, a transmitter 300, and a controller 40. However, it is possible to incorporate a variety of other components into the system 10, such as receiver collars, watering devices, feeding devices, pet doors, or other devices desired to be controlled based on the location of the pet. Moreover, although the components are illustrated in the figures as separate units, it is possible to combine these components into a single unit, multiple units, or combination units, without departing from the scope and spirit of the present general inventive concept.

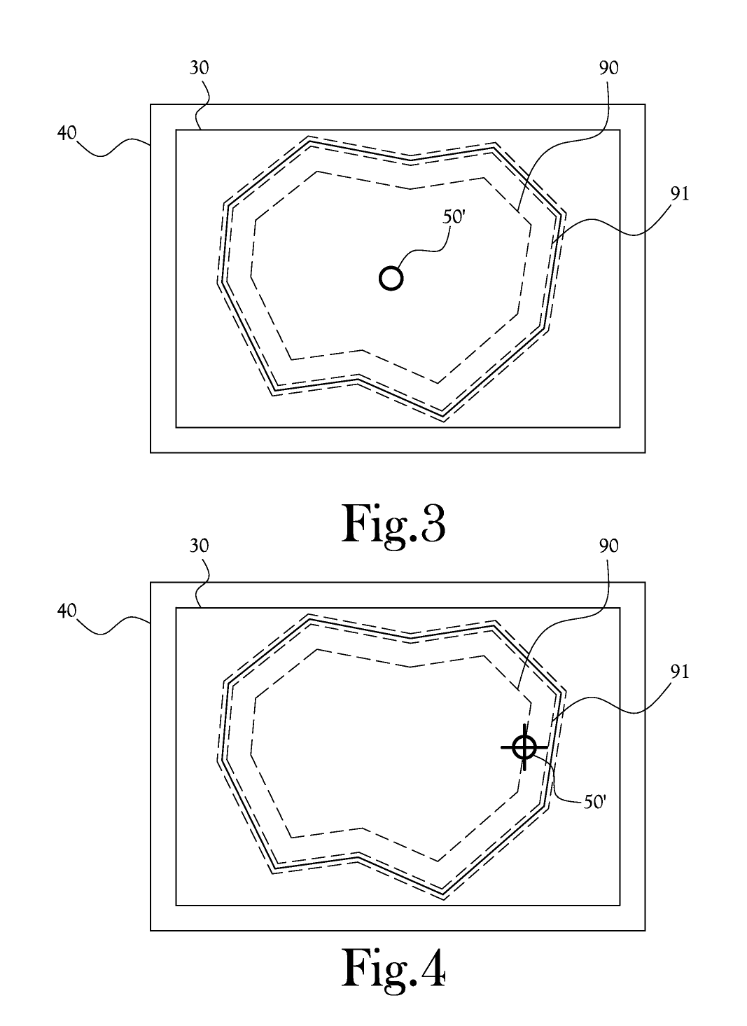

FIGS. 3 and 4 illustrate an example layout of a user interface configured in accordance with an example embodiment of the present general inventive concept to enable a user to draw a virtual containment boundary 25 within the camera field of view 100. In some embodiments, the controller 40 can include an object recognition unit to recognize objects within the camera field of view 100 in order to automatically define a boundary area, without the use of the user interface. For example, the object recognition unit can recognize the presence of boundary markers, such as tape, stakes, trees, buildings, landscaping, furniture, or other marking elements to facilitate boundary-line definition.

The controller 40 can analyze camera images for presence of user signals, such as hand gestures, that correspond to known user commands. For example, the controller 40 can compare sensed movements in the camera field against reference data contained in a lookup table to determine whether the user has performed a predetermined command. Upon determining the user has performed a predetermined command, the controller 40 can generate a signal for transmission to the animal, or an associated device, based on the sensed signal from the user.

Referring to FIGS. 3 and 4, a user interface 30 can communicate with the controller 40 to perform visual recognition routines to review the bounded area 25 in real time and to visually track the pet 50 within the bounded area 25. In some embodiments, the pet 50 can be wearing a collar-mounted beacon device 51 recognizable by the visual recognition system such that the collar device can deliver a correction signal to the pet in response to a command of the camera system, for example when the pet 50 approaches a boundary zone, such as warning zone 90 or correction zone 91 of the containment boundary 25. For example, the beacon can emit a light signal in whatever spectrum, and the image sensing device (or camera) can detect the signal and transmit a command to the collar device to encourage or discourage the animal from performing a particular behavior. The command can be based on a location of the beacon device relative to a predetermined border, and/or the location of other beacons worn by other animals in the field of view. The command can also control other devices, such as animal feeders/watering devices, pet doors, litter boxes, toys, etc., and can transmit signals to activate and/or deactivate such devices based on one or more animal's location. In some embodiments that implement an infrared heat detector, a beacon is not required to be worn by the animal as the detector can detect the location of a still or moving heat source (animal) to transmit an appropriate command to the animal or other device.

Accordingly, the present general inventive concept is not limited to the use of a separate beacon or collar device to detect a location of the pet or to deliver the stimulation signal. In some embodiments, it is possible to track the pet 50 or other animals without the use of a separate beacon or collar device, for example using infra-red heat detectors, and to deliver a correction signal, such as an ultrasonic correction signal, to dissuade the pet 50 from crossing the boundary, without the use of a separate beacon, collar or receiver device, using the transmitter 300. It is also possible to track the presence of other animals that may be approaching the boundary 25, and deliver a stimulus, such as ultrasound, to dissuade the animal from entering the boundary 25.

In some embodiments, the beacon device can transmit a uniquely coded signal to allow the stimulation signal to have a unique characteristic as programmed by the user to recognize presence of the animal. Further, different beacon devices could be programmed with different borders to permit multiple animals with different containment objectives to be monitored and controlled within the same field(s) of view. For example, in a household with multiple dogs and cats, it is possible to set-up different objectives for each animal, such as keeping the dog off of the sofa and chair and containing the dog within the room, but allowing the cat access to the chair and freedom to leave the room. Moreover, it is possible for the user to interact with the animal when the person is in the camera field of view along with the pet, to stimulate the animal and/or to activate a device such as a treat dispenser, a pet door, a toy, a litter box, pee pad, animal feeder/watering device, and the like, from within the field of view using a gesture command recognized by the controller 40.

The concepts and techniques disclosed herein are not limited to any particular type of pets or animals, and could be applied to various other applications and objects, without departing from the scope and spirit of the present general inventive concept. For example, although the accompanying figures illustrate a dog, the present general inventive concept is not limited to any particular type of animal.

Referring to FIGS. 1 to 4, the user can draw a virtual containment boundary 25 into a usable area of the camera field of view 100 using the user interface 30. This virtual boundary 25 can be displayed on a display screen using set-up tools provided by the user interface 30 and controller 40. The controller 40 can include a processor having circuitry to compare the location of the boundary 25 to the roving location of the pet 50, such that when the pet approaches or intersects a boundary zone, such as warning zone 90, the system alerts a transmitter 300 to send a correction signal to the pet, for example an ultrasonic correction signal, or a static signal transmitted via a receiver collar worn by the pet, to dissuade the pet from escaping the boundary 25. As an example, the receiver beacon could be collar mounted or ankle mounted to a dog. Different types or levels of stimulation signals can be assigned to any number of border zones using the techniques of the present general inventive concept.

The present general inventive concept is not limited to any particular type of transmitted signals, and many other types of warning, correction, or control signals could also be sent to the pet or other devices, for example vibration signals, aromatic signals, static signals, sound signals, or virtually any other type of animal modification signal, without departing from the broader scope and spirit of the present general inventive concept. For example, in some embodiments, one or more transmitters 300 can be strategically positioned around the operational environment to transmit sound signals and/or sprays to animals based on the location of the animal relative to a boundary zone, to adjust the behavior or the animal. In other embodiments, the transmitter 300 can transmit a control signal to a stimulus delivery device, such as an animal correction collar, to deliver an electronic and/or vibration signal to the animal to dissuade the animal from crossing a boundary. It is also possible for the transmitter 300 to transmit notification signals to a user, or pet owner, in the event the pet 50 approaches or escapes a boundary zone. For example, the transmitter 300 can transmit email, text, telephonic, pager, or other known or later developed messaging protocols to the user to notify the user that the pet, or other object, is approaching or escaping the predetermined boundary 25. The transmitter/receiver link can be configured as a wired or wireless link, including but not limited to, RF, WiFi, Bluetooth, IR, Soundwave.

As illustrated in FIGS. 1 to 4, the pet containment boundary 25 can include one or more boundary zones, such as warning zone 90 and correction zone 91. The present general inventive concept is not limited to any particular number, size, or type of boundary zones, and the user can be provided with set-up tools to adjust the number, size, and/or type of boundary zones surrounding the boundary 25, and to choose the type and/or level of signal to be applied in response to locations at each boundary. For example, the user could define any number of zones leading up to the boundary 25, and could assign progressively higher levels and/or types of stimulation to each successive zone.

As illustrated in FIGS. 1 and 2, the camera 20 can be mounted in a fixed location to feed images to the visual recognition system of the controller 40 to track the pet in relation to the virtual boundary 25. In some embodiments, the pet can be equipped with a collar having a colored or IR LED visible to the camera. In some embodiments, the LED can act as a beacon for the visual recognition system to track the pet's location. Once the pet gets near the boundary, the system 10 can activate an output to send a signal to the pet as a warning tone, a spray, a vibration, or static stimulation. In some embodiments, the camera 20 can be a pan-tilt camera, wherein the controller 40 compares the pet's dynamic position to the total field of view of the camera(s) to track the position of the pet 50. Should the camera 20 lose vision, the controller 40 can predict current position based on historical position data recorded in the control unit. It is also possible to program the controller 40 to assist the user in positioning the cameras to optimize fields of view. Depth perception cameras can also be used to improve visual recognition operations. The camera system can include the controller and transmitter as an integrated component, or as separate units.

FIGS. 3 and 4 illustrate a display screen having a user interface 30 illustrating movement of the pet relative to the containment border corresponding to FIGS. 1 and 2, respectively. In the embodiment illustrated in FIG. 3, the user interface 30 can display the location of the pet as a circle 50′ corresponding to the pet, for example the pet's center of gravity. The present general inventive concept is not limited to any particular type of icon for display, and is not limited to identifying the pet's center of gravity, but could track other portions of the pet, such as the pet's neck, head, or feet.

Referring to FIG. 4, when the pet 50′ approaches a boundary zone, such as warning zone 90, the user interface 30 can display a cross-hair (or other icon) to indicate that the pet is approaching or intersecting a border zone. The transmitter 300 can transmit a warning signal, pre-selected by the user or automatically assigned to the warning zone 90, to dissuade the pet from escaping the containment boundary 25. Should the pet 50′ approach or intersect the correction zone 91, the transmitter can deliver a higher level or different type of correction signal to further dissuade the pet from escaping the containment boundary 25. The user can define any number of border zones and assign various levels and/or types of stimulation signals to each zone, as desired.

The controller 40 can be a PC connected to the camera 20 and transmitter 300, separately or as an integrated unit, to carry out the operations of the present general inventive concept. However, the present general concept is not limited to a PC, and the controller 40 could be configured to run on a board, chip, or a variety of other configurations chosen with sound engineering judgment, separately or as an integrated unit with the camera 20 and transmitter 300, including a processor circuitry programmed to carry out the operations of the present general inventive concept, such as visual recognition operations, boundary definition operations, correction signal operations, camera control operations, and transmitter operations. The user interface 30 can enable a user to view the camera fields of view remotely, if desired.

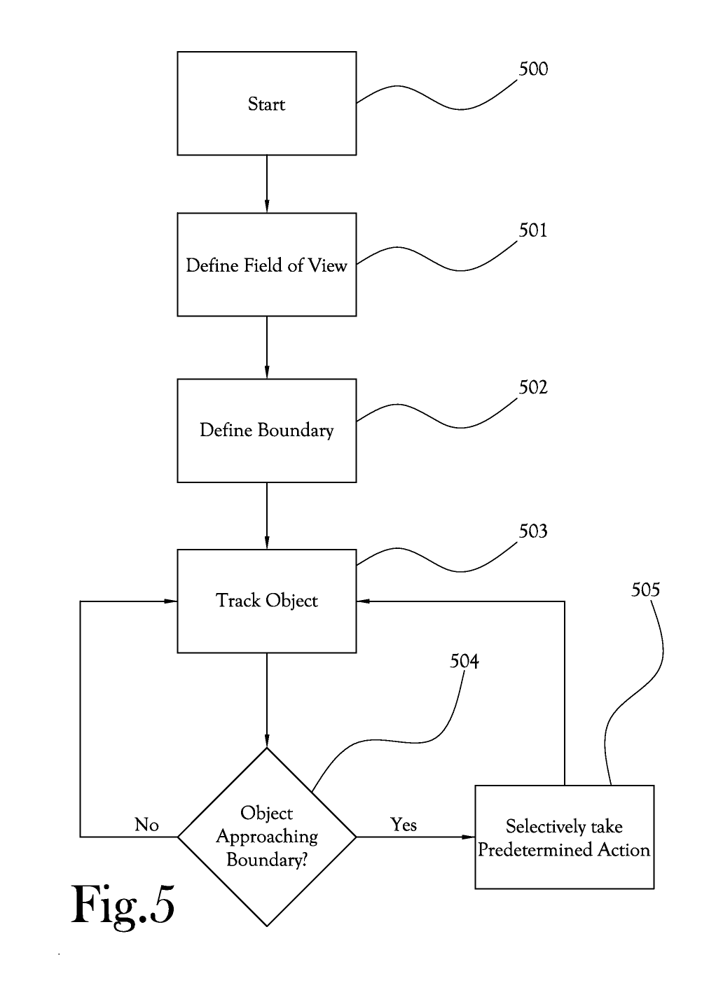

FIG. 5 is a flow chart illustrating an example routine performed by circuitry programmed to track an object according to an example embodiment of the present general inventive concept. Operation 501 defines a field of view of the camera. One of more cameras, for example one or more of a fixed, night vision, dual, or pan/tilt type, can be chosen with sound engineering judgment to optimize the usable field of view. Operation 502 enables a user to draw a pet containment boundary based on the camera(s) field of view. Operation 503 utilizes visual recognition routines to track the object within the field of view. The camera can recognize a beacon carried by the object, or can detect the object itself, for example using infra-red detectors. The location of the object is compared to the boundary in operation 504 to determine whether the object is approaching or intersecting a boundary. If yes, operation 505 takes predetermined action to dissuade the object from escaping the boundary, and/or can notify a user of the object's status.

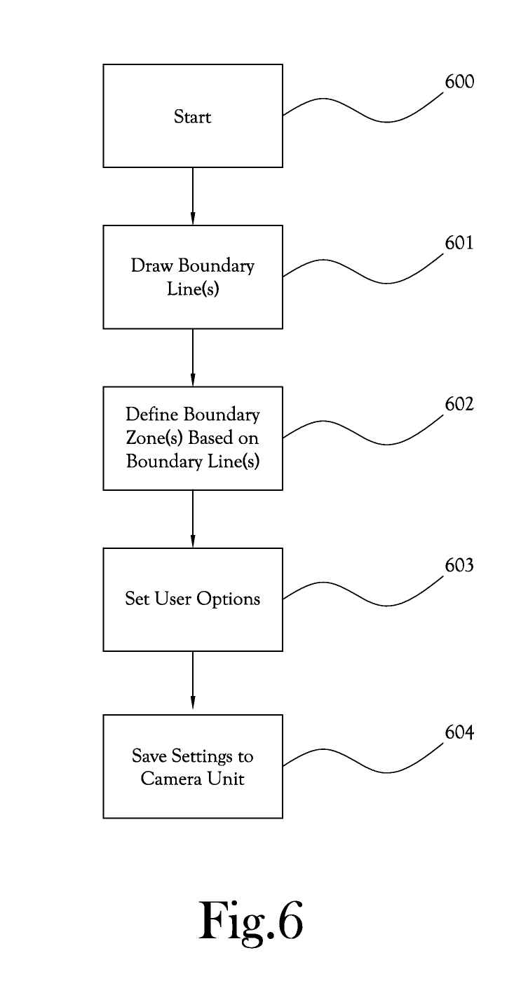

FIG. 6 is a flow chart illustrating an example routine performed by circuitry programmed to define a pet containment boundary according to an example embodiment of the present general inventive concept. Operation 601 enables a user to draw pet containment boundary lines, for example using a graphical user interface showing the camera usable field of view. In operation 602, the user can define one or more boundary zones surrounding the drawn pet containment boundary lines. In operation 603, the user can set user-options, for example, to set the size of various boundary zones, set times of operation, set times of network availability, set challenge and escape notification options, set multiple pet options, set levels and/or types of stimulation signals for each zone, etc. The settings information can be saved to the camera unit in operation 604.

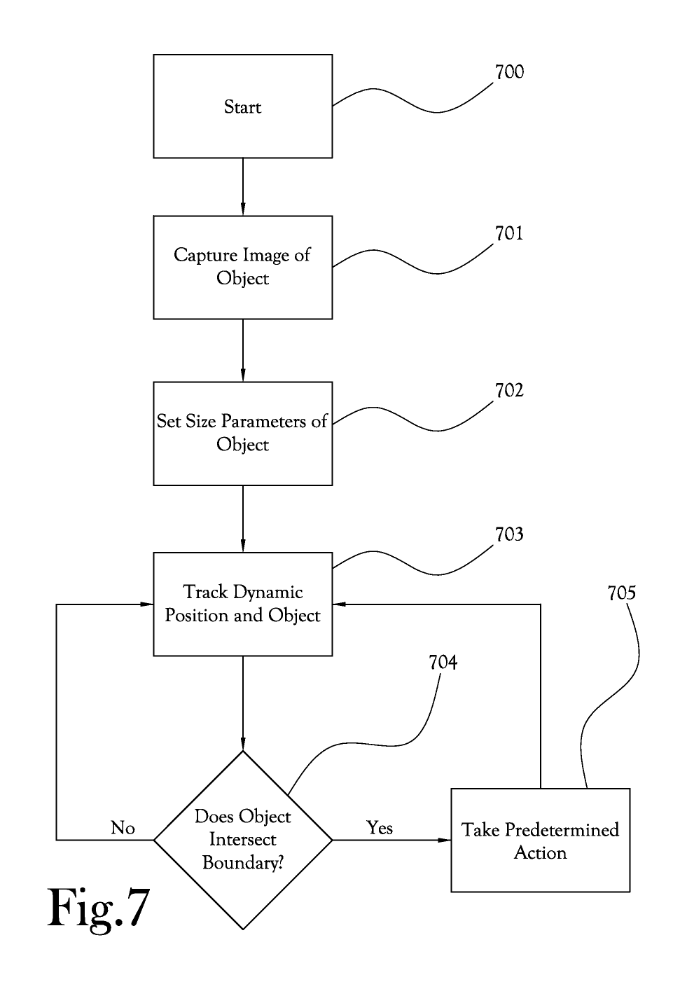

FIG. 7 is a flow chart illustrating an example routine performed by circuitry programmed to track an object according to an example embodiment of the present general inventive concept. Operation 701 enables the camera(s) to capture an image of the object. In some embodiments, the pet can be equipped with a collar having a colored or IR LED visible to the camera, or the camera can detect the object itself, for example using infra-red filters and detectors. An RGB filter can turn off all pixels except those of the beacon or object. In operation 702, the system can set size parameters of the object. For example, a blob size filter can turn beacon pixels into a blob, and can set size parameters. In one embodiment, the object's center of gravity can be calculated and compared to the pet containment border for tracking purposes. The center of gravity of the object can be depicted by a circle icon (or other icon) on the user interface and the borders can be depicted by various types of lines. Operation 703 utilizes visual recognition routines to track the dynamic position of the object within the pet containment border. The location of the object is compared to the boundary lines in operation 704 to determine whether the object is approaching or intersecting a boundary zone. If yes, operation 705 takes predetermined action to dissuade the object from escaping the boundary, and/or can notify a user of the object's status. The user interface can display a cross-hair or other icon on the object when the object crosses into a border zone.

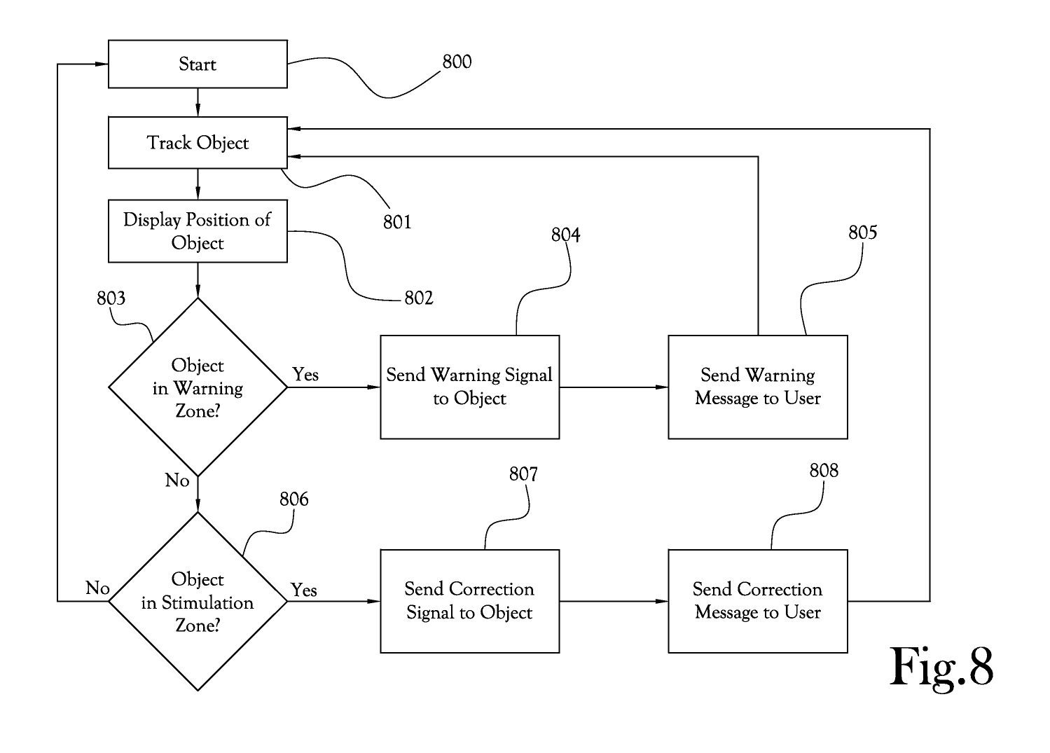

FIG. 8 is a flow chart illustrating an example routine performed by circuitry programmed to track an object relative to boundary zones according to an example embodiment of the present general inventive concept. Operation 801 utilizes visual recognition routines to track the dynamic position of the object within the pet containment border. In operation 802, the position of the object can be displayed to the user via a user interface on the camera or other output device, such as a monitor. For example, in some embodiments, the location of the object can be depicted by a circle icon (or other icon) on a display screen of the camera or other monitor, and the borders and zones can be depicted by various types and/or colors of solid or dotted lines. In operation 803, it can be determined whether the object is approaching a warning zone near the pet containment border, and if so, send a warning signal to the object in operation 804 and optionally send a warning message to the user in operation 805. In operation 806, it can be determined whether the object is approaching a stimulation zone, and if so, send a correction signal to the object in operation 807 and optionally send a correction message to the user.

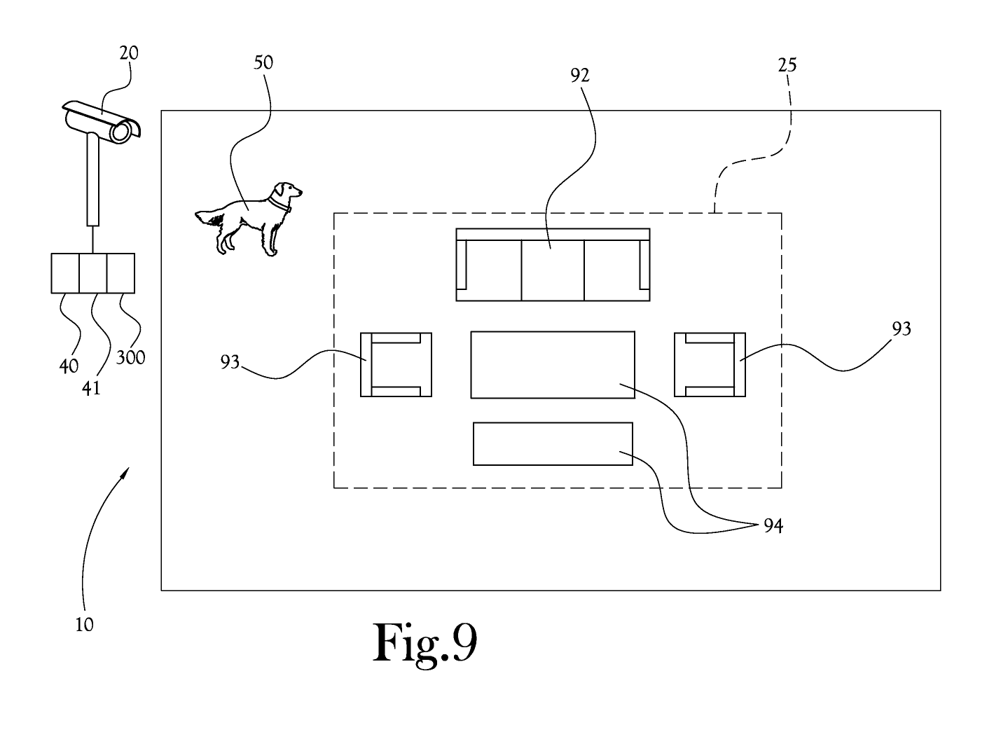

FIG. 9 is a perspective view of a system environment illustrating a pet 50 attempting to enter a defined boundary 25 surrounding an indoor restricted area, such as a living room, according to an example embodiment of the present general inventive concept. Here, the camera 20 can be positioned to view a restricted area, such as a living or dining area, in which the pet is restricted from entering. To define the boundary, the user can place markers such as tape, stakes, or other recognizable elements around the restricted area to indicate the boundary to the camera. In some embodiments, the object recognition unit 41 recognizes objects such as couch 92, chair 93, and table 94 to generate the boundary 25 within predetermined parameters. The camera can also include a user interface to enable the user to draw a boundary within the field of view of the camera. Should the animal 50 approach the boundary 25, the transmitter 300 transmits a stimulation signal to dissuade the animal from crossing the boundary. The controller 40 can determine the direction in which the animal is approaching the boundary (e.g., whether the animal is entering or exiting the boundary), and can selectively control the transmitter 300 to transmit a particular stimulus signal (or no signal at all) based on the status of the animal with respect to the boundary. For example, if it is determined that the animal is attempting to exit a restricted boundary or re-enter a containment boundary, the system may refrain from transmitting a stimulation signal, or may select to transmit a positive stimulation signal to encourage the animal's corrective behavior.

FIG. 10 is a perspective view of a system environment illustrating a user 120 providing control signals to the camera 20 in accordance with an example embodiment of the present general inventive concept. In this example embodiment, the controller 40 recognizes images displayed in the camera field of view, such as the user's hand movements from A to D displaying the user's arm bending from a lower position to an upper position with their palm upward. Here, the controller 40 can analyze the user's movement captured by the camera 20, and can compare the movement with predetermined image information stored in the controller 40, for example in a lookup table, to determine whether the user performed a recognizable command. If so, the system can transmit a signal to the animal and/or to associated devices via the transmitter 300. Example devices include a treat dispenser 112, pet door 114, toy 116, and receiver collar 51, but a variety of different signals and/or devices could be used without departing from the scope and spirit of the present general inventive concept. In FIG. 10, the user's gesture could be interpreted, for example, to open or close the pet door 114, to dispense a pet treat 112, to activate a toy 116, or to transmit a stimulus to the animal 50 via the receiver collar 51. The system can also include a microphone 125 to detect audible sounds, such as barks, to help determine whether corrected action is required, as well as to speak to the animal if needed. For example, a microphone 125 could be used to trigger a stimulation signal when nuisance barking is detected. Further, microphone 125 and speaker 130 could be used to facilitate bi-directional internet communication, for example to communicate with the animal remotely, if desired, both visually and audibly, to calm or praise the dog, as needed.

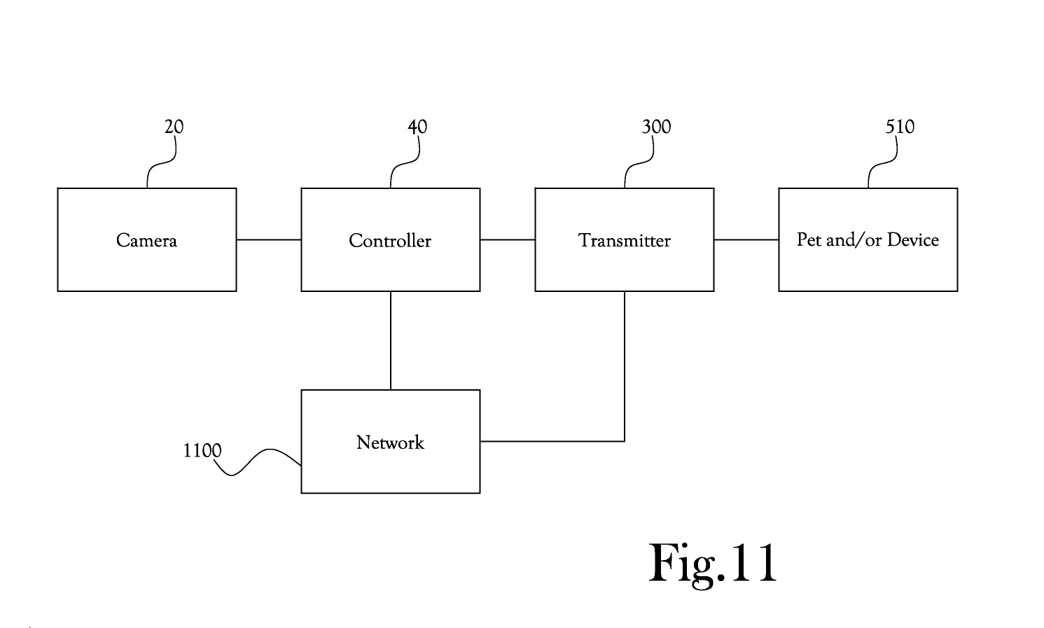

FIG. 11 is a block diagram of a camera-based control system configured in accordance with an example embodiment of the present general inventive concept. The example system includes a camera 20, controller 40, transmitter 300, network 1100, and controlled device 510. The controller 40 can determined whether a detected image from the camera 20 warrants the transmitter 300 to transmit a control signal to the pet and/or device 510. The transmitter 300 can be connected to a network 1100, wired or wireless, to transmit signals, such as notification signals, to a remote user in the event the pet 50 approaches or escapes a boundary zone. For example, the transmitter 300 can transmit email, text, telephonic, pager, or other known or later developed messaging protocols to the user to notify the user that the pet, or other object, is approaching or escaping the predetermined boundary 25. The user can also transmit control signals to the pet and/or device 510 to remotely generate a stimulation signal over the internet while viewing the camera 20.

The transmitter/receiver link can be configured as a wired or wireless link, including but not limited to, RF, WiFi, Bluetooth, Ethernet, IR, Soundwave. Thus, the system can allow a user to interact with a pet and associated devices when the user is in the field of view of the camera along with the pet, or remotely.

It is noted that the simplified diagrams and drawings do not illustrate all the various connections and assemblies of the various components, however, those skilled in the art will understand how to implement such connections and assemblies, based on the illustrated components, figures, and descriptions provided herein, using sound engineering judgment.

Embodiments of the present general inventive concept provide behavior recognition systems and methods of identifying pet activities to trigger a customized reaction. Examples include, but are not limited to, bad behavior, good behavior, eating, sleeping, running, jumping, counter surfing, playing, etc.

It is possible to visualize the displays to see a pet on smart phone or computer connected to internet and to remotely see and interact with the pet using two-way voice. The escape warning signals can be implemented via email, text, voicemail, push notification on a mobile device, social network, etc.

The camera can take boundary testing snapshots and escape snapshots. It is possible to identify an intruder in the boundary snapshots, for example, other dogs, people, etc.

It is possible to incorporate car recognition systems into the pet containment system so as to create auto boundary adjustments where the boundary is close to a road.

A reactive boundary can be used to judge the speed of pet and adjust the boundary for a longer correction signal. The system can identify potential threats to the pet and adjust the boundary accordingly. The system can identify changes in recognized objects, such as moved furniture, and can adjust the boundary accordingly.

The visual recognition system can be configured for pet identification, i.e., pet face recognition, to recognize pets and intruding animals.

The system can interact with remote toys and other stimulation techniques and systems.

In some embodiments, the controller can share video feed from the camera in order to interact with the pet through social networking sites and apps (phone, tablet, computer, etc.)

It is possible to set-up multiple remote cameras to follow pets throughout the house. The system can remotely actuate devices using the stimulation signals for fun, convenience or conservation (i.e. to enable feeding systems, watering systems, warming beds, toys, unlock/open pet doors, open doors, ring doorbells, wired/wireless fence systems, electronic collars, etc., based on the tracked location of the pet relative to a predetermined border).

The present general inventive concept can be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

While the present general inventive concept has been illustrated by description of several example embodiments, it is not the intention of the applicant to restrict or in any way limit the scope of the inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings.

1. An animal control system, comprising:
a camera system to visualize a location of an animal within a field of view of the camera system;
a controller to define a border within the field of view and to compare the location of the animal relative to the defined border; and
a transmitter to transmit a stimulation signal to the animal to dissuade the animal from crossing the border based on the comparison.

2. The animal control system of claim 1, further comprising:
a user interface to enable a user to define the border.

3. The animal control system of claim 1, wherein the controller includes an object recognition unit to recognize an object within the field of view such that the controller defines the border based on a location of the object.

4. The animal control system of claim 1, wherein the controller controls the transmitter to selectively change a characteristic of the stimulation signal based on a distance of the animal from the border.

5. The animal control system of claim 1, wherein the animal control system is connected to a network, and the stimulation signal is transmitted to the animal based on a user input via the network as the user views the animal over the network.

6. The animal control system of claim 1, further comprising:
a beacon device carried by the animal to transmit a tracking signal to the camera system and to receive the stimulation signal to deliver a stimulus to the animal.

7. The animal control system of claim 5, further comprising:
multiple beacon devices carried by different animals, wherein each beacon device defines a different operational characteristic such that one animal is prevented from crossing a predefined border, while a different animal is permitted to cross the predefined border.

8. The animal containment system of claim 1, wherein the stimulation signal is an ultrasound signal.

9. The animal containment system of claim 1, wherein the stimulation signal is a spray.

10. The animal containment system of claim 6, wherein the stimulus is vibration.

11. The animal containment system of claim 6, wherein the stimulus is electrical.

12. The animal containment system of claim 1, wherein the camera system includes one or more cameras.

13. The animal containment system of claim 12, wherein the one or more cameras include one or more of a fixed camera, a panning camera, a dual camera, a night vision camera, or combinations thereof.

14. The animal containment system of claim 1, wherein the controller predicts the location of the animal based on historical location points of the animal when the camera system loses vision of the animal.

15. An animal tracking system, comprising:
a camera system to visualize a location of an animal within a field of view of the camera system;
a controller to define a animal containment border within the field of view and to compare the location of the animal relative to the defined border; and
a transmitter to transmit a control signal to actuate a predetermined device in the vicinity of the animal based on the comparison.

16. The animal tracking system of claim 15, wherein the predetermined device is one of a feeding system, a watering system, a warming bed, a pet door, a toy, a treat dispenser, a peed pad, a litter box, a receiver collar, or combinations thereof.

17. The animal tracking system of claim 15, further comprising multiple beacon devices carried by different animals to transmit corresponding tracking signals to the camera, wherein each beacon device defines a different operational characteristic such that one animal is prevented from accessing a predetermined device while a different animal is permitted to access the predetermined device.

18. A method of tracking an animal, comprising:
visualizing a location of an animal within a field of view of one or more cameras;
defining a border within the field of view;
comparing a location of the animal relative to the defined border; and
transmitting a signal to the animal to dissuade the animal from crossing the border based on the comparison of the animal's location.

19. The method of claim 18, wherein the defining operation comprises recognizing an object within the field of view, and defining the border based on a location of the recognized object.

20. The method of claim 18, wherein the transmitted signal encourages the animal to cross the border.

21. The method of claim 18, wherein the transmitted signal is generated based on a user input provided from within the field of view.

22. The method of claim 18, wherein the transmitted signal is generated based on a user input provided remotely over a network.

23. A camera system to track a location of an animal, comprising
a viewing element to establish a field of view of the camera system;
a controller to define a border within the field of view and to compare the location of the animal relative to the defined border; and
a transmitter to transmit a stimulation signal to the animal to adjust a behavior of the animal based on the comparison.

24. The camera system of claim 23, wherein the stimulation signal dissuades the animal from crossing the border.

25. The camera system of claim 23, wherein the border defines one or more of a restrictive area and a containment area, and the stimulation signal dissuades the animal from entering the restrictive area and/or leaving the containment area.

26. An animal tracking system, comprising:
a camera system to visualize an animal and a user within a field of view of the camera system;
a controller to analyze movement of the user in the field of view to determine whether the movement constitutes a control command; and
a transmitter to transmit a control signal to the animal and/or to actuate a predetermined device associated with the animal.

27. An animal control system, comprising:
an image sensing device to detect the presence of an animal within a field of view of the image sensing device;
a controller to determine a location of the animal relative to the field of view; and
a transmitter to transmit a stimulation signal to the animal to elicit a desired behavior of the animal based on the location of animal within the field of view.

28. The animal control system of claim 27, wherein the image sensing device detects a light signal emitted from a beacon device worn by the animal, an infrared heat signal emitted by the animal, and/or a gesture performed by a user within the field of view.

29. An animal control system, comprising:
an image sensing device to detect the presence of an animal within a field of view of the image sensing device;
a controller to determine a location of the animal relative to the field of view; and
a transmitter to transmit a command signal to an object in proximity to the animal based on the location of the animal within the field of view.

30. The animal control system of claim 29, wherein the image sensing device detects a light signal emitted from a beacon device worn by the animal, an infrared heat signal emitted by the animal, and/or a gesture performed by a user within the field of view.
